(19) United States
(12) Patent Application Publication
(10) Pub. No.: US 2025/0231468 A1
(43) Pub. Date: Jul. 17, 2025

(54) PROJECTION SYSTEM AND ADJUSTMENT MECHANISM

(71) Applicant: SEIKO EPSON CORPORATION, Tokyo (JP)

(72) Inventors: Katsunori TANAKA, Azumino-shi (JP); Hirotaka YANAGISAWA, Azumino-shi (JP); Manae MIYATA, Matsukawa-mura (JP); Yoshitsugu AKUTAGAWA, Azumino-shi (JP)

(73) Assignee: SEIKO EPSON CORPORATION, Tokyo (JP)

(21) Appl. No.: 19/016,092

(22) Filed: Jan. 10, 2025

(30) Foreign Application Priority Data
Jan. 12, 2024 (JP) 2024-003326

(51) Int. Cl. G03B 21/14

(52) U.S. Cl. CPC G03B 21/142; G03B 21/145

(57) ABSTRACT

A projection system includes a light source configured to output light; a light modulator configured to modulate the light output from the light source; a projection optical apparatus configured to project the light modulated by the light modulator; and an adjustment mechanism disposed at a side of the projection optical apparatus toward which the light is projected from the projection optical apparatus. The adjustment mechanism includes a movable section provided to be movable relative to the projection optical apparatus. The adjustment mechanism is so configured that a traveling direction of the light projected from the projection optical apparatus is changed by the movable section moving relative to the projection optical apparatus.

The present application is based on, and claims priority from JP Application Serial Number 2024-003326, filed Jan. 12, 2024, the disclosure of which is hereby incorporated by reference herein in its entirety.

### BACKGROUND

### 1. Technical Field

The present disclosure relates to a projection system and an adjustment mechanism.

### 2. Related Art

There is a known projector having a structure that allows a user to adjust an elevation angle of a projection lens by adjusting the amount of protrusion of a primary leg, which protrudes from the bottom surface of a housing, from the bottom surface, as disclosed, for example, in JP-A-2007-304146.

JP-A-2012-173699 and JP-A-2007-304146 are examples of the related art.

In the aforementioned method for adjusting the amount of protrusion of the primary leg, it is difficult to widen the range of the adjustable angle of the projection lens, and there is therefore a difficulty in projecting light to a desired location. In particular, there is a problem of a difficulty in projecting light toward the installation surface at which the primary leg is installed. To address the problem, for example, JP-A-2012-173699 describes a shift mechanism that moves an optical unit including a projection system in a direction perpendicular to the optical axis of the projection system. Using the shift mechanism allows the direction in which light is projected to be readily changed. In this case, however, providing the shift mechanism causes a problem of an increase in the size of the projector.

### SUMMARY

A projection system according to an aspect of the present disclosure includes a light source configured to output light; a light modulator configured to modulate the light output from the light source; a projection optical apparatus configured to project the light modulated by the light modulator; and an adjustment mechanism disposed at a side of the projection optical apparatus toward which the light is projected from the projection optical apparatus. The adjustment mechanism includes a movable section provided to be movable relative to the projection optical apparatus, and is so configured that a traveling direction of the light projected from the projection optical apparatus is changed by the movable section moving relative to the projection optical apparatus.

An adjustment mechanism according to another aspect of the present disclosure is attached to a projector including a light source configured to output light, a light modulator configured to modulate the light output from the light source, and a projection optical apparatus configured to project the light modulated by the light modulator. The adjustment mechanism includes a movable section provided to be movable relative to the projection optical apparatus, and is disposed at a side of the projection optical apparatus toward which the light is projected from the projection optical apparatus. The adjustment mechanism is so configured that a traveling direction of the light projected from the projection optical apparatus is changed by the movable section moving relative to the projection optical apparatus.

### BRIEF DESCRIPTION OF THE DRAWINGS

FIG. 1 is a schematic configuration diagram showing a projection system according to a first embodiment.

FIG. 2 shows the projection system according to the first embodiment viewed in a rightward-leftward direction.

FIG. 3 is a perspective view showing the projection system according to the first embodiment.

FIG. 4 is an exploded perspective view showing the projection system according to the first embodiment.

FIG. 5 is an exploded perspective view showing the projection system according to the first embodiment, and shows the projection system viewed in an oblique direction different from that in FIG. 4.

FIG. 6 is a perspective view showing an adjustment mechanism in the first embodiment.

FIG. 7 is an exploded perspective view showing the adjustment mechanism in the first embodiment.

FIG. 8 is a partial cross-sectional view showing the adjustment mechanism in the first embodiment.

FIG. 9 is a partial cross-sectional view showing the adjustment mechanism in the first embodiment, and shows a state in which the movable section is rotated relative to the adjustment mechanism shown in FIG. 8 around an axis of rotation.

FIG. 10 shows the projection system according to the first embodiment viewed in the rightward-leftward direction in a state in which the movable section is rotated relative to the projection system shown in FIG. 2 around the axis of rotation.

FIG. 11 shows the projection system according to the first embodiment viewed in the rightward-leftward direction in a state in which the movable section is further rotated relative to the projection system shown in FIG. 10 around the axis of rotation.

FIG. 12 show an adjustment mechanism including a different optical element in the first embodiment and viewed in the rightward-leftward direction.

FIG. 13 is a partial cross-sectional view showing a portion of a projection system according to a second embodiment.

FIG. 14 shows a portion of a projection system according to a third embodiment viewed in the rightward-leftward direction.

FIG. 15 shows a portion of the projection system according to the third embodiment viewed in the rightward-leftward direction in a state in which a movable section inclines upward.

FIG. 16 shows a portion of the projection system according to the third embodiment viewed in the rightward-leftward direction in a state in which the movable section inclines downward.

FIG. 17 shows a projection system according to a fourth embodiment.

### DESCRIPTION OF EMBODIMENTS

Embodiments of the present disclosure will be described below with reference to the drawings. The scope of the present disclosure is not limited to the following embodiments, and can be changed in any manner within the scope of the technical idea of the present disclosure. In the following drawings, the scale, the number, and other factors of each structure differ from those in an actual structure in some cases for clarity of each configuration.

The drawings each show an X-axis, a Y-axis, and a Z-axis. The X-axis indicates one horizontal direction. The Y axis indicates another horizontal direction. The Z-axis indicates the vertical direction. In the following description, a horizontal direction along the X-axis is called a “frontward-rearward direction X”, a horizontal direction along the Y-axis is called a “rightward-leftward direction Y”, and a vertical direction along the Z-axis is called a “vertical direction Z”. The frontward-rearward direction X, the rightward-leftward direction Y, and the vertical direction Z are directions perpendicular to each other. In the vertical direction Z, the side to which the arrow of the Z-axis points (+Z side) is an upper side, and the side opposite the side to which the arrow of the Z-axis points (−Z side) is a lower side. In the following description, in the frontward-rearward direction X, the side to which the arrow of the X-axis points (+X side) is defined as a front side, and the side opposite the side to which the arrow of the X-axis points (−X side) is defined as a rear side.

### First Embodiment

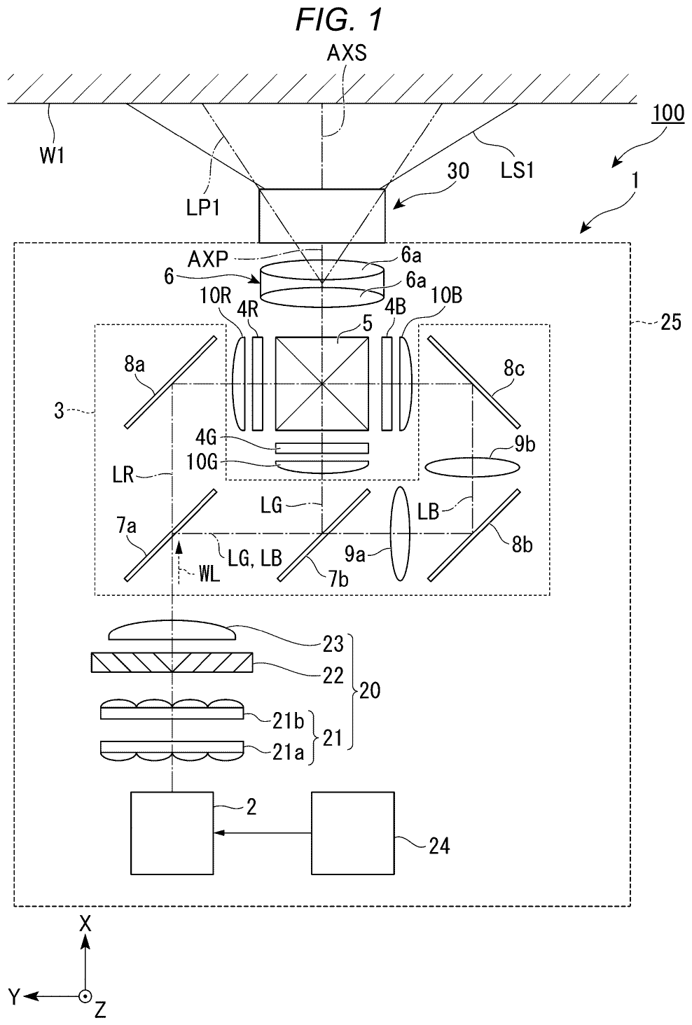

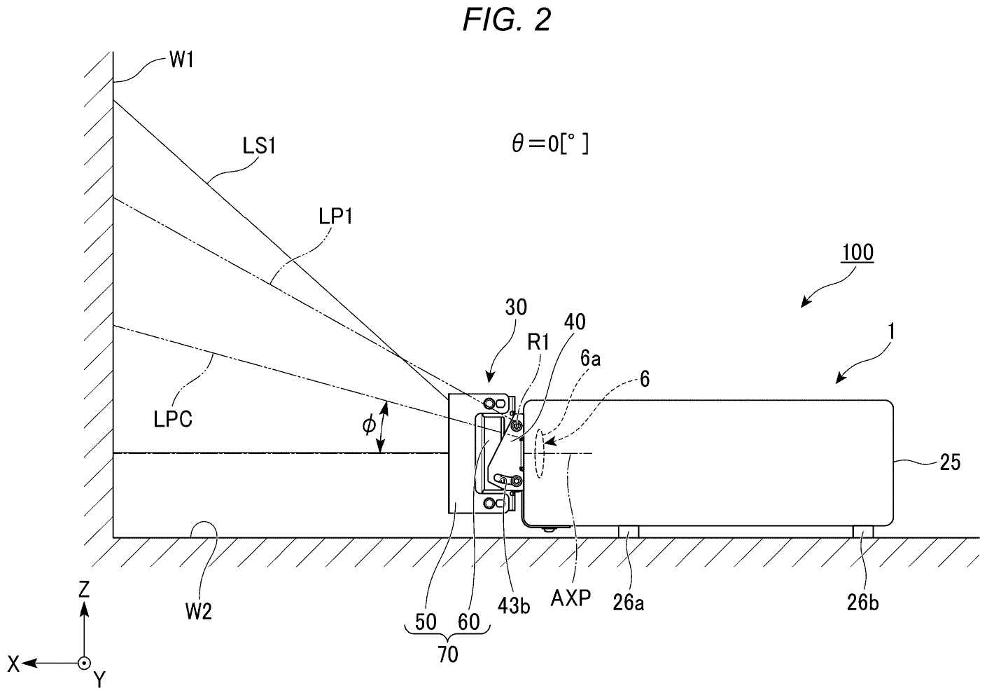

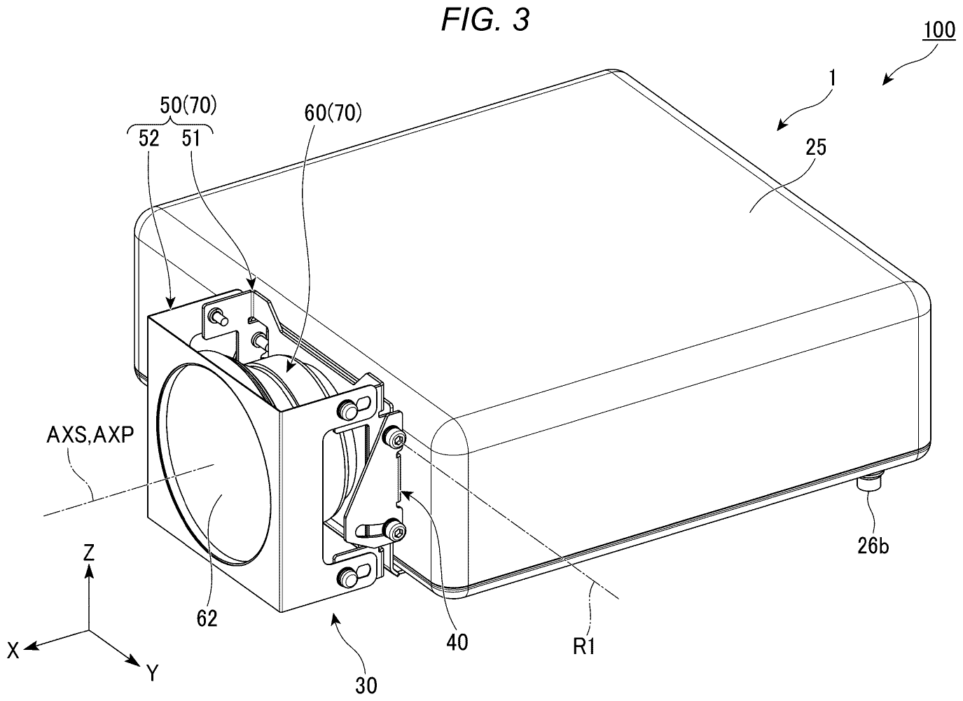

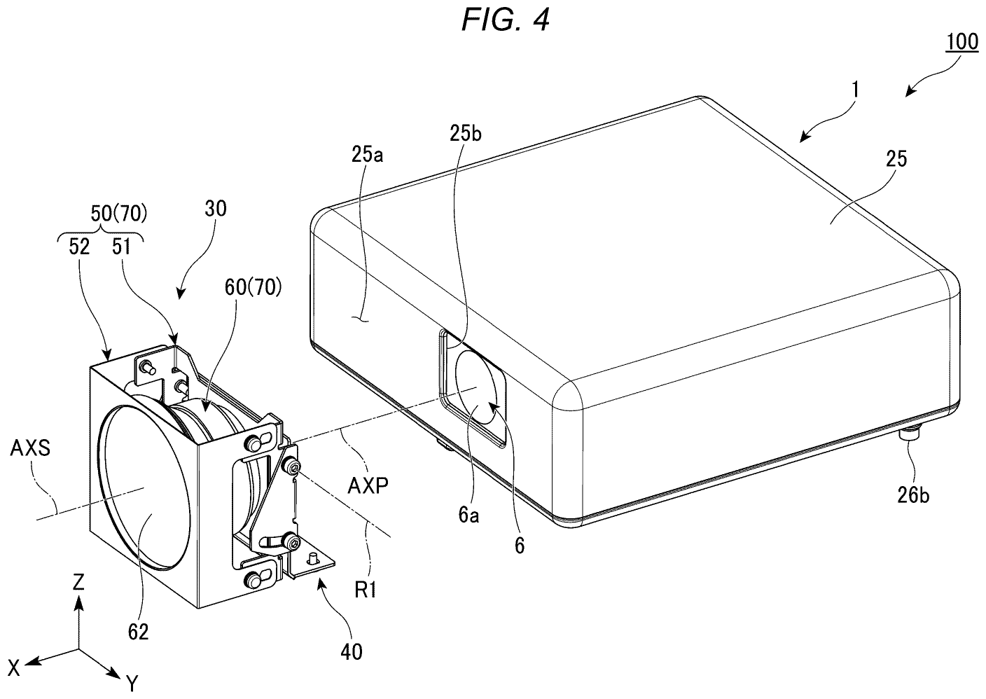

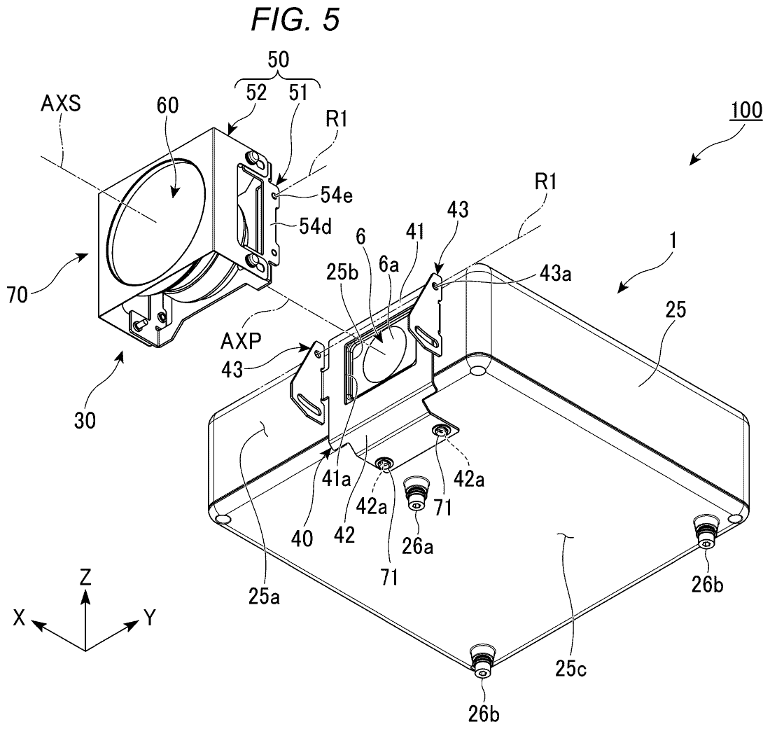

FIG. 1 is a schematic configuration diagram showing a projection system 100 according to the present embodiment. FIG. 2 shows the projection system 100 viewed in the rightward-leftward direction Y. FIG. 3 is a perspective view showing the projection system 100. FIG. 4 is an exploded perspective view showing the projection system 100. FIG. 5 is an exploded perspective view showing the projection system 100, and shows the projection system 100 viewed in an oblique direction different from that in FIG. 4.

The projection system 100 according to the embodiment includes a projector 1 and an adjustment mechanism 30, as shown in FIG. 1. The projector 1 in the present embodiment is a projection-type image display apparatus that projects a color image. In the present embodiment, a case where the projector 1 is installed at an installation surface W2 facing upward will be described, as shown in FIG. 2. The installation surface W2 is a planar surface perpendicular to the vertical direction Z. The color image projected from the projector 1 is projected at least onto a sidewall surface W1 extending upward from the installation surface W2. The sidewall surface W1 is a surface located frontward of the projector 1 and facing rearward. The sidewall surface W1 is a planar surface perpendicular to the frontward-rearward direction X.

The projector 1 includes a light source 2, a homogenized illumination system 20, a color separation system 3, light modulators 4R, 4G, and 4B, a light combining system 5, a projection optical apparatus 6, and a controller 24, as shown in FIG. 1. The light source 2 outputs light. In the present embodiment, the light source 2 outputs illumination light WL toward the homogenized illumination system 20. The light source 2 is controlled by the controller 24.

The homogenized illumination system 20 includes an optical integration system 21, a polarization converter 22, and a superimposing system 23. The optical integration system 21 includes a first lens array 21a and a second lens array 21b. The homogenized illumination system 20 homogenizes the intensity distribution of the illumination light WL output from the light source 2 at each of the light modulators 4R, 4G, and 4B, which are illumination receiving regions. The illumination light WL output from the homogenized illumination system 20 enters the color separation system 3.

The color separation system 3 separates the illumination light WL, which is white light, into red light LR, green light LG, and blue light LB. The color separation system 3 includes a first dichroic mirror 7a, a second dichroic mirror 7b, a first reflection mirror 8a, a second reflection mirror 8b, a third reflection mirror 8c, a first relay lens 9a, and a second relay lens 9b.

The first dichroic mirror 7a separates the illumination light WL from the light source 2 into the red light LR and the other light, that is, the green light LG and the blue light LB. The first dichroic mirror 7a transmits the separated red light LR and reflects the other light, that is, the green light LG and the blue light LB. The second dichroic mirror 7b separates the other light into the green light LG and the blue light LB. The second dichroic mirror 7b reflects the separated green light LG and transmits the separated blue light LB.

The first reflection mirror 8a is disposed in the optical path of the red light LR and reflects the red light LR having passed through the first dichroic mirror 7a toward the light modulator 4R. The second reflection mirror 8b and the third reflection mirror 8c are disposed in the optical path of the blue light LB and reflect the blue light LB having passed through the second dichroic mirror 7b toward the light modulator 4B. The green light LG is reflected off the second dichroic mirror 7b toward the light modulator 4G.

The first relay lens 9a and the second relay lens 9b are disposed in the optical path of the blue light LB at positions facing the light exiting side of the second dichroic mirror 7b. The first relay lens 9a and the second relay lens 9b correct the difference in illumination distribution of the blue light LB due to the fact that the optical path length of the blue light LB is longer than the optical path length of the red light LR and the optical path length of the green light LG.

The light modulators 4R, 4G, and 4B modulate the light output from the light source 2. The light modulator 4R modulates the red light LR in accordance with image information to form image light corresponding to the red light LR. The light modulator 4G modulates the green light LG in accordance with image information to form image light corresponding to the green light LG. The light modulator 4B modulates the blue light LB in accordance with image information to form an image light corresponding to the blue light LB.

The light modulators 4R, 4G, and 4B are each, for example, a transmissive liquid crystal panel. Polarizers that are not shown are disposed at the light incident side and the light exiting side of each of the liquid crystal panels to allow only light linearly polarized in a specific direction to pass through the liquid crystal panel.

Field lenses 10R, 10G, and 10B are disposed at the light incident side of the light modulators 4R, 4G, and 4B, respectively. The field lenses 10R, 10G, and 10B parallelize the chief rays of the red light LR, the green light LG, and the blue light LB to be incident on the light modulators 4R, 4G, and 4B, respectively.

When the image light output from the light modulator 4R, the image light output from the light modulator 4G, and the image light output from the light modulator 4B enter the light combining system 5, the light combining system 5 combines the image light corresponding to the red light LR, the image light corresponding to the green light LG, and the image light corresponding to the blue light LB with one another and outputs the combined image light toward the projection optical apparatus 6. The light combining system 5 is, for example, a cross dichroic prism.

The projection optical apparatus 6 projects the image light modulated by the light modulators 4R, 4G, and 4B. In the present embodiment, the projection optical apparatus 6 includes multiple projection lenses 6a arranged in the frontward-rearward direction X. The projection optical apparatus 6 enlarges combined image light LP1 from the light combining system 5 and projects the enlarged image light frontward. The image light LP1 projected from the projection optical apparatus 6 enters the adjustment mechanism 30.

An optical axis AXP of the projection optical apparatus 6 extends in parallel to the frontward-rearward direction X, as shown in FIG. 2. The image light LP1 projected frontward from the projection optical apparatus 6 spreads in the vertical direction Z and the rightward-leftward direction Y as traveling frontward. In the present embodiment, the image light LP1 projected from the projection optical apparatus 6 is projected in a direction offset upward in the vertical direction Z (first side in second direction) from the optical axis AXP of the projection optical apparatus 6. The expression “the image light LP1 is offset upward” means that a center line LPC passing through the center of the image light LP1 in the vertical direction Z is located above the optical axis AXP. The center line LPC moves upward as extending frontward. The angle of the center line LPC with respect to the optical axis AXP is a throwing angle φ. The throwing angle φ is, for example, greater than or equal to about 5° but smaller than or equal to 30°. In the present embodiment, the lower edge of the image light LP1 coincides with the optical axis AXP in the vertical direction Z. The upper edge of the image light LP1 moves upward as the image light LP1 travels frontward.

The projector 1 includes an enclosure 25, which houses the light source 2 and the light modulators 4R, 4G, and 4B therein. In the present embodiment, the enclosure 25 houses the light source 2, the homogenized illumination system 20, the color separation system 3, the light modulators 4R, 4G, and 4B, the light combining system 5, the projection optical apparatus 6, and the controller 24, as shown in FIG. 1.

The enclosure 25 has the shape of a substantially cuboidal box, as shown in FIG. 3. The dimension of the enclosure 25 in the frontward-rearward direction X is greater then the dimension of the enclosure 25 in the rightward-leftward direction Y. The dimension of the enclosure 25 in the vertical direction Z is smaller than the dimension of the enclosure 25 in the rightward-leftward direction Y. An opening 25b is formed in a front surface 25a of the enclosure 25, as shown in FIG. 4. The opening 25b is a substantially rectangular hole elongated in the rightward-leftward direction Y. The projection lens 6a located at the foremost position out of the multiple projection lenses 6a of the projection optical apparatus 6 is exposed out of the enclosure 25 via the opening 25b. The optical axis of the projection lenses 6a, that is, the optical axis AXP of the projection optical apparatus 6 passes through the opening 25b.

A front leg 26a and rear legs 26b are provided at a lower surface 25c of the enclosure 25, as shown in FIG. 5. The front leg 26a and the rear legs 26b protrude downward from the lower surface 25c. The front leg 26a is located frontward of the rear legs 26b. In the present embodiment, one front leg 26a is provided at a central portion of the lower surface 25c in the rightward-leftward direction Y. Two rear legs 26b are provided at an interval in the rightward-leftward direction Y. The lower end of the front leg 26a and the lower ends of the rear legs 26b are in contact with the installation surface W2, as shown in FIG. 2. The projector 1 is installed at the installation surface W2 via the front leg 26a and the rear legs 26b.

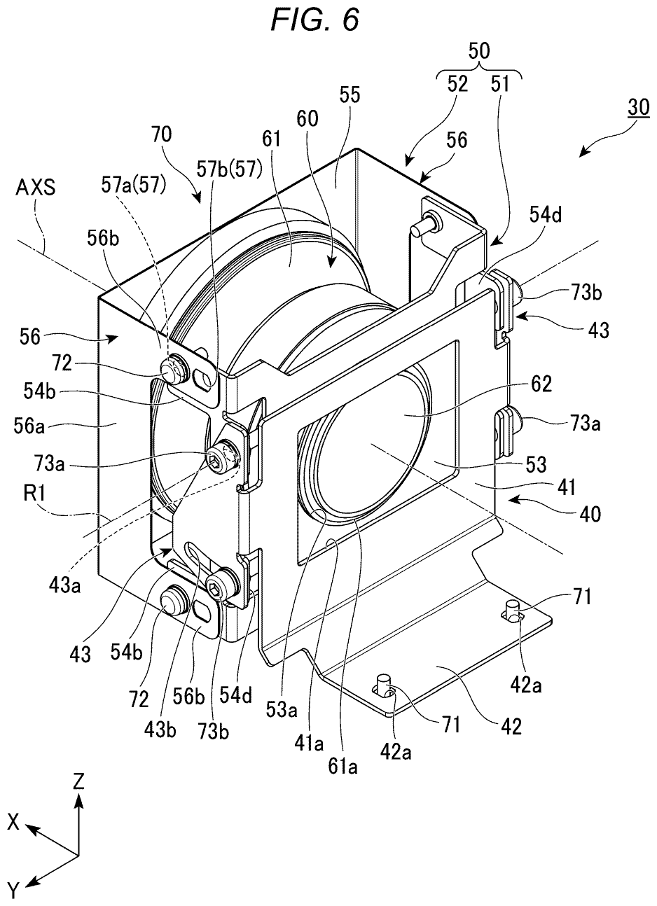

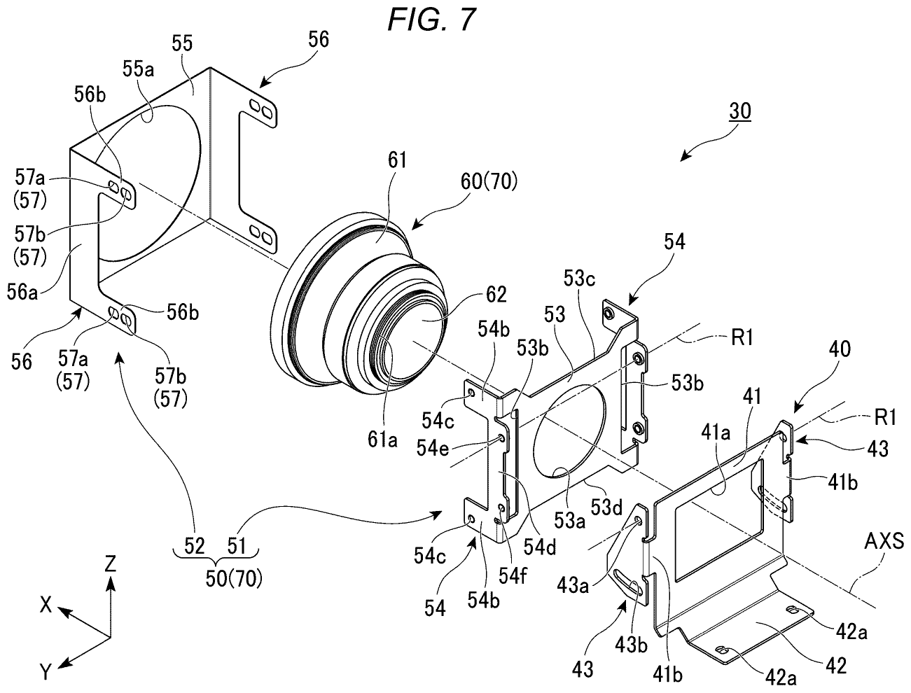

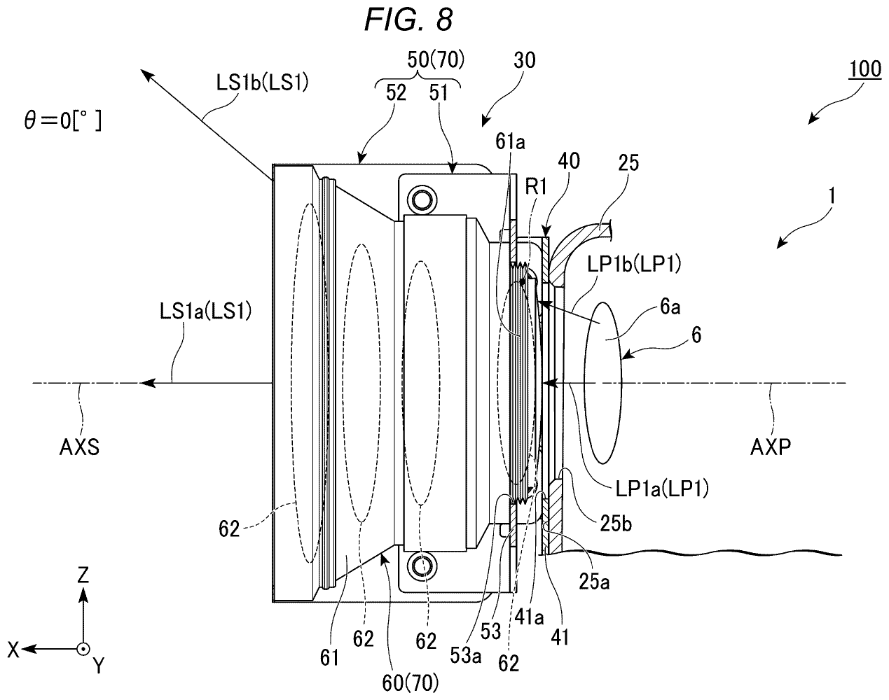

The adjustment mechanism 30 is disposed at the side toward which light is projected from the projection optical apparatus 6, that is, at the front side of the projection optical apparatus 6. In the present embodiment, the adjustment mechanism 30 is attached to the projector 1. More specifically, the adjustment mechanism 30 is detachably attached to the enclosure 25. The adjustment mechanism 30 is a mechanism that changes the traveling direction of the light projected from the projection optical apparatus 6, that is, the image light LP1. FIG. 6 is a perspective view showing the adjustment mechanism 30. FIG. 7 is an exploded perspective view showing the adjustment mechanism 30. FIG. 8 is a partial cross-sectional view showing the adjustment mechanism 30. The adjustment mechanism 30 includes a fixed member 40 and a movable section 70, as shown in FIG. 6.

In the following description, consider a target of interest, and a side close to the center of the adjustment mechanism 30 in the rightward-leftward direction Y may be called an “inner side in the rightward-leftward direction”, and a side far from the center of the adjustment mechanism 30 in the rightward-leftward direction Y may be called an “outer side in the rightward-leftward direction”. In the present embodiment, the center of the adjustment mechanism 30 in the rightward-leftward direction Y coincides with an optical axis AXS of an optical element 60, which will be described later, in the rightward-leftward direction Y.

The fixed member 40 is a member fixed to the enclosure 25. In the present embodiment, the fixed member 40 is a sheet metal member, as shown in FIG. 7. The fixed member 40 includes a front wall section 41, a lower wall section 42, and a pair of attachment sections 43. The front wall section 41 has plate surfaces oriented in the frontward-rearward direction X and having the shape of a substantially rectangular plate elongated in the rightward-leftward direction Y. A through hole 41a is formed in the front wall section 41. The through hole 41a is a rectangular hole elongated in the rightward-leftward direction Y. The front wall section 41 is located frontward of the front surface 25a of the enclosure 25, as shown in FIG. 8. The rear surface of the front wall section 41 is in contact with the front surface 25a. The through hole 41a overlaps with the opening 25b when viewed in the frontward-rearward direction X. Protrusions 41b, which protrude outward in the rightward-leftward direction, are formed at the opposite edges of the front wall section 41 at the outer side in the rightward-leftward direction, as shown in FIG. 7.

The lower wall section 42 protrudes rearward from the lower end of the front wall section 41, as shown in FIG. 7. The lower wall section 42 has the shape of a plate having plate surfaces oriented in the vertical direction Z. Holes 42a passing through the lower wall section 42 in the vertical direction Z are formed in the lower wall section 42. Two holes 42a are formed at an interval in the rightward-leftward direction Y. The lower wall section 42 is located below the lower surface 25c of the enclosure 25, as shown in FIG. 5. The upper surface of the lower wall section 42 is in contact with the lower surface 25c. A threaded member 71 passes through each of the holes 42a from below. The threaded members 71 passing through the respective holes 42a are fastened to the lower surface 25c of the enclosure 25. In the present embodiment, the fixed member 40 is detachably fixed to the enclosure 25 with the two threaded members 71.

The pair of attachment sections 43 are linked to the protrusions 41b formed at the opposite edges of the front wall section 41 in the rightward-leftward direction, specifically, to the ends of the protrusions 41b at the outer sides in the rightward-leftward direction Y, as shown in FIG. 7. The pair of attachment sections 43 protrude frontward from the pair of protrusions 41b. The pair of attachment sections 43 protrude from the pair of protrusions 41b toward the opposite sides in the vertical direction Z. In the present embodiment, the pair of attachment sections 43 each have the shape of a plate having plate surfaces oriented in the rightward-leftward direction Y. The pair of attachment sections 43 each have the shape of a substantially triangular plate being convex upward. The pair of attachment sections 43 are disposed at an interval in the rightward-leftward direction Y.

The attachment sections 43 each have a support hole 43a and a guide hole 43b formed therein, the holes passing through the attachment section 43 in the rightward-leftward direction Y. The support holes 43a are each formed in a portion of the attachment section 43 that is located above the protrusion 41b. In the present embodiment, the support holes 43a are each a circular hole. An axis of rotation R1, which is an imaginary line extending in the rightward-leftward direction Y, passes through the support holes 43a. The axis of rotation R1 is an axis of rotation extending in the rightward-leftward direction (first direction) Y perpendicular to the optical axis AXP of the projection optical apparatus 6.

In the present embodiment, the rightward-leftward direction Y corresponds to a “first direction” perpendicular to the optical axis AXP of the projection optical apparatus 6, and the vertical direction Z corresponds to a “second direction” perpendicular to both the optical axis AXP of the projection optical apparatus 6 and the first direction. The upper side in the vertical direction Z corresponds to a “first side in the second direction”, and the lower side in the vertical direction Z corresponds to a “second side in the second direction”.

The guide holes 43b are each formed in a portion of the attachment section 43 that is located below the protrusion 41b. The guide holes 43b are disposed away from the support holes 43a in the radial direction from the axis of rotation R1 as the center. The guide holes 43b are located below the support holes 43a. The guide holes 43b extend in the circumferential direction around the axis of rotation R1. The guide holes 43b are each an arcuate hole. In the present embodiment, the guide holes 43b each extend frontward arcuately from a portion of the attachment section 43 that is located immediately below the support hole 43a. The rear end of each of the guide holes 43b is located immediately below the support hole 43a. The guide holes 43b protrude frontward beyond the support holes 43a.

The movable section 70 is a portion provided to be movable relative to the projection optical apparatus 6. In the present embodiment, the movable section 70 is rotatable with respect to the projection optical apparatus 6 around the axis of rotation R1, which extends in the rightward-leftward direction Y perpendicular to the optical axis AXP of the projection optical apparatus 6. In the present embodiment, the movable section 70 is rotatable with respect to the fixed member 40 around the axis of rotation R1 and therefore rotatable with respect to the projection optical apparatus 6 around the axis of rotation R1. It is assumed that an angle of rotation θ of the movable section 70 around the axis of rotation R1 is 0[°] in the state shown in FIG. 8. It is assumed that the relative positional relationship among the portions in the description below is a relative positional relationship in the state in which the angle of rotation θ of the movable section 70 is 0[°] unless otherwise specified. When the angle of rotation θ of the movable section 70 is 0[°], the frontward-rearward direction X is the direction in which the optical axis AXS of the optical element 60 extends.

In the present embodiment, the movable section 70 is attached to the fixed member 40, as shown in FIG. 6. The movable section 70 is located frontward of the fixed member 40. The movable section 70 is sandwiched between the pair of attachment sections 43 in the rightward-leftward direction Y. The movable section 70 includes a holder 50 and the optical element 60.

The image light LP1 projected from the projection optical apparatus 6 enters the optical element 60, as shown in FIG. 8. In the present embodiment, the optical element 60 is an optical element that widens the angle of view of the image light LP1 projected from the projection optical apparatus 6. The optical element 60 is, for example, a wide converter lens. The optical element 60 outputs the image light LP1 incident from the projection optical apparatus 6 frontward as image light LS1 having a widened angle of view. The optical axis AXS of the optical element 60 coincides with the optical axis AXP of the projection optical apparatus 6 when the angle of rotation θ of the movable section 70 is 0[°]. When the angle of rotation θ of the movable section 70 is 0[°], the optical axis AXS of the optical element 60 extends in parallel to the frontward-rearward direction X.

The optical element 60 includes a lens barrel 61 and multiple lenses 62. The lens barrel 61 has a multi-stepped, substantially cylindrical shape extending along the optical axis AXS. The outer diameter of the front end of the lens barrel 61 is greater than the outer diameter of the rear end of the lens barrel 61. A threaded section 61a is formed at a rear end portion of the lens barrel 61. The optical element 60 is externally attachable, for example, to a camera lens via the threaded section 61a. The multiple lenses 62 are housed in the lens barrel 61. The multiple lenses 62 are arranged in the direction in which the optical axis AXS extends. The rearmost lens 62 out of the multiple lenses 62 faces the foremost projection lens 6a in the projection optical apparatus 6.

The holder 50 holds the optical element 60. The holder 50 includes a first holding member 51 and a second holding member 52, which sandwich the optical element 60 in the direction in which the optical axis AXS of the optical element 60 extends. The first holding member 51 and the second holding member 52 are fixed to each other. The first holding member 51 is attached to the fixed member 40 to be rotatable around the axis of rotation R1. The second holding member 52 is located frontward of the first holding member 51. In the present embodiment, the first holding member 51 and the second holding member 52 are each a sheet metal member, as shown in FIG. 7.

The first holding member 51 includes a first wall section 53 and a pair of first linkage sections 54. The first wall section 53 has the shape of a plate having plate surface oriented in the frontward-rearward direction X. A recess 53c recessed downward is formed at the upper edge of the first wall section 53. A recess 53d recessed upward is formed at the lower edge of the first wall section 53. The recesses 53c and 53d extend in the rightward-leftward direction Y. Through holes 53b, which pass through the first wall section 53 in the frontward-rearward direction X, are formed in opposite edge portions of the first wall section 53 at the outer side in the rightward-leftward direction. The through holes 53b are each a substantially rectangular hole elongated in the vertical direction Z. The first wall section 53 is disposed so as to face the front side of the front wall section 41 of the fixed member 40, as shown in FIG. 8. The first wall section 53 is provided frontward of and away from the front wall section 41.

The first wall section 53 has an insertion hole 53a formed therein, which passes through the first wall section 53 in the frontward-rearward direction X. The insertion hole 53a is a circular hole around the optical axis AXS. A rear portion of the optical element 60 passes through the insertion hole 53a. In the present embodiment, the threaded section 61a of the lens barrel 61 passes through the insertion hole 53a. The threaded section 61a is, for example, loosely fitted into the insertion hole 53a. The rear end portion of the optical element 60 protrudes rearward beyond the insertion hole 53a. A portion of the optical element 60 that is located rearward of the insertion hole 53a is located in the gap in the frontward-rearward direction X between the first wall section 53 and the front wall section 41.

The pair of first linkage sections 54 are linked to the opposite edges of the first wall section 53 at the outer side in the rightward-leftward direction, as shown in FIG. 7. The pair of first linkage sections 54 each have the shape of a plate having plate surfaces oriented in the rightward-leftward direction Y. The pair of first linkage sections 54 protrude toward the opposite sides in the frontward-rearward direction X from the first wall section 53. The pair of first linkage sections 54 form edge portions of the pair of through holes 53b at the outer side in the rightward-leftward direction. The pair of first linkage sections 54 are disposed to be symmetric in the rightward-leftward direction Y. The pair of first linkage sections 54 each include a first linkage wall section 54b and a second linkage wall section 54d.

The first linkage wall sections 54b protrude frontward from edge portions of the first wall section 53 at the outer side in the rightward-leftward direction. A pair of first linkage wall sections 54b are provided at an interval in the vertical direction Z at each side in the rightward-leftward direction. The upper first linkage wall sections 54b of the pairs of first linkage wall sections 54b protrude frontward from edge portions of the first wall section 53 at the outer side in the rightward-leftward direction that are located above the through holes 53b. The lower first linkage wall sections 54b of the pairs of first linkage wall sections 54b protrude frontward from edge portions of the first wall section 53 at the outer side in the rightward-leftward direction that are located below the through holes 53b. The first linkage wall sections 54b each have a threaded hole 54c formed therein, which passes through the first linkage wall section 54b in the rightward-leftward direction Y.

The second linkage wall sections 54d are each located between the pair of first linkage wall sections 54b in the vertical direction Z. The second linkage wall sections 54d extend in the vertical direction Z. The second linkage wall sections 54d each link the pair of first linkage wall sections 54b to each other. The second linkage wall sections 54d and the through holes 53b are provided at the same position in the vertical direction Z. The second linkage wall sections 54d protrude rearward from the first wall section 53. A first threaded hole 54e and a second threaded hole 54f are formed in each of the second linkage wall sections 54d. The first threaded holes 54e are formed in upper portions of the second linkage wall sections 54d. The first threaded holes 54e are located below the threaded holes 54c formed in the first linkage wall sections 54b located above. The axis of rotation R1 passes through the first threaded holes 54e. The second threaded holes 54f are formed in lower portions of the second linkage wall sections 54d. The second threaded holes 54f are located below the first threaded holes 54e. The second threaded holes 54f are located above the threaded holes 54c formed in the first linkage wall sections 54b located below.

The second linkage wall sections 54d are located at the inner side of the attachment sections 43 of the fixed member 40 in the rightward-leftward direction, as shown in FIG. 6. The second linkage wall sections 54d of the pair of first linkage sections 54 are sandwiched by the pair of attachment sections 43 in the rightward-leftward direction Y. The pair of second linkage wall sections 54d are in contact with the pair of attachment sections 43. The pair of second linkage wall sections 54d are attached to the pair of attachment sections 43 with first threaded members 73a and second threaded members 73b. The first threaded members 73a pass through the support holes 43a of the attachment sections 43 from the outer side in the rightward-leftward direction and are fastened into the first threaded holes 54e of the second linkage wall sections 54d. The axis of rotation R1 passes through the first threaded members 73a. The second threaded members 73b pass through the guide holes 43b of the attachment sections 43 from the outer side in the rightward-leftward direction and are fastened into the second threaded holes 54f of the second linkage wall sections 54d. The movable section 70 is thus attached to the fixed member 40 with the first threaded members 73a passing through the support holes 43a and the second threaded members 73b passing through the guide holes 43b.

In the state in which the first threaded members 73a and the second threaded members 73b are loosened, the first holding member 51 is rotatable around the axis of rotation R1 within a range over which the second threaded members 73b are movable in the guide holes 43b. The movable section 70 is therefore rotatable around the axis of rotation R1 relative to the fixed member 40 and the projection optical apparatus 6. In a state in which the movable section 70 is rotated around the axis of rotation R1 with respect to the fixed member 40 and the projection optical apparatus 6 and the angle of rotation θ of the movable section 70 is set a desired angle, the angle of rotation θ of the movable section 70 can be fixed to the desired angle by tightening the first threaded members 73a and the second threaded members 73b.

The second holding member 52 includes a second wall section 55 and a pair of second linkage sections 56, as shown in FIG. 7. The second wall section 55 has the shape of a plate having plate surface oriented in the frontward-rearward direction X. The second wall section 55 and the first wall section 53 sandwich the optical element 60 in the frontward-rearward direction X. The second wall section 55 has a projection hole 55a formed therein, which passes through the second wall section 55 in the frontward-rearward direction X. The projection hole 55a is a circular hole around the optical axis AXS. The inner diameter of the projection hole 55a is greater than the inner diameter of the insertion hole 53a. The inner diameter of the projection hole 55a is smaller than the outer diameter of the front end of the optical element 60. An outer circumferential edge portion of the front end surface of the optical element 60 is in contact with a circumferential edge portion around the projection hole 55a out of the rear surface of the second wall section 55.

The pair of second linkage sections 56 protrude rearward from the opposite edges of the second wall section 55 at the outer side in the rightward-leftward direction. The pair of second linkage sections 56 each have the shape of a plate having plate surfaces oriented in the rightward-leftward direction Y. The pair of second linkage sections 56 face each other at an interval in the rightward-leftward direction Y. The second linkage sections 56 each include a base section 56a and third linkage wall sections 56b. The base sections 56a are portions linked to the edges of the second wall section 55 at the outer side in the rightward-leftward direction. The base sections 56a extend in the vertical direction Z. The third linkage wall sections 56b protrude rearward from the base sections 56a. A pair of third linkage wall sections 56b are provided at an interval in the vertical direction Z at each side in the rightward-leftward direction. One of the third linkage wall sections 56b protrudes rearward from an upper end portion of the base section 56a. The other third linkage wall section 56b protrudes rearward from a lower end portion of the base section 56a. The pair of third linkage wall sections 56b are located at the outer side of the pair of first linkage wall sections 54b in the rightward-leftward direction, and are in contact with the pair of first linkage wall sections 54b, as shown in FIG. 6.

Fixing holes 57 are formed in the second holding member 52. In the present embodiment, the fixing holes 57 are formed in each of the third linkage wall sections 56b. The fixing holes 57 are holes through which threaded members 72, which fix the second holding member 52 to the first holding member 51, can pass. The fixing holes 57 pass through the third linkage wall sections 56b in the rightward-leftward direction Y. In the present embodiment, multiple fixing holes 57 are formed in each of the third linkage wall sections 56b side by side in the frontward-rearward direction X. The fixing holes 57 are each a hole having a dimension in the rightward-leftward direction Y greater than the dimension in the vertical direction Z. That is, the projection system 100 according to the present embodiment satisfies the following two conditions: adjacent ones of the multiple fixing holes 57 are formed side by side in the direction in which the optical axis AXS of the optical element 60 extends; and the fixing holes 57 are each a hole elongated in the direction in which the optical axis AXS of the optical element 60 extends.

In the present embodiment, the third linkage wall sections 56b are each provided with two fixing holes 57, a first fixing hole 57a and a second fixing hole 57b. The first fixing hole 57a is located frontward of the second fixing hole 57b. In the present embodiment, the threaded members 72 pass through the first fixing holes 57a in the rightward-leftward direction Y. The threaded members 72 having passed through the first fixing holes 57a from the outer side in the rightward-leftward direction are fastened into the threaded holes 54c formed in the first linkage wall sections 54b. The first holding member 51 and the second holding member 52 are thus fixed to each other. In the present embodiment, the first holding member 51 and the second holding member 52 are fixed to each other with four threaded members 72.

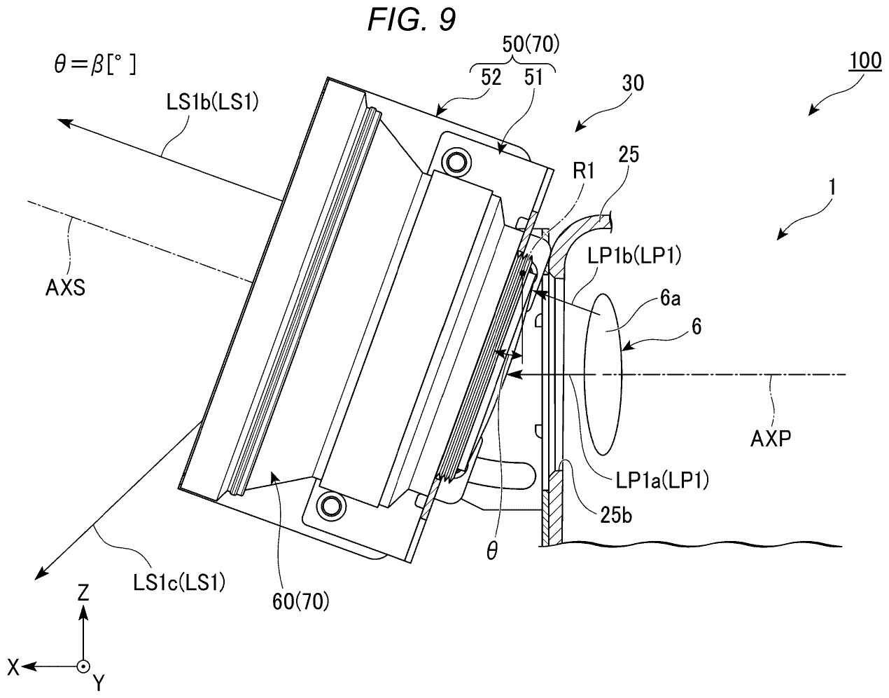

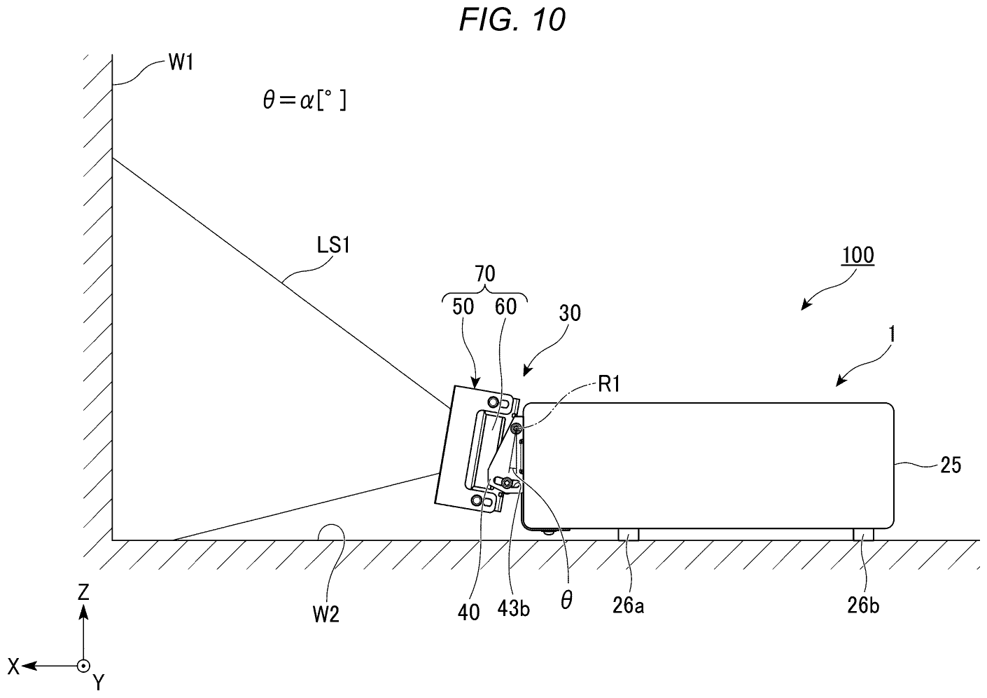

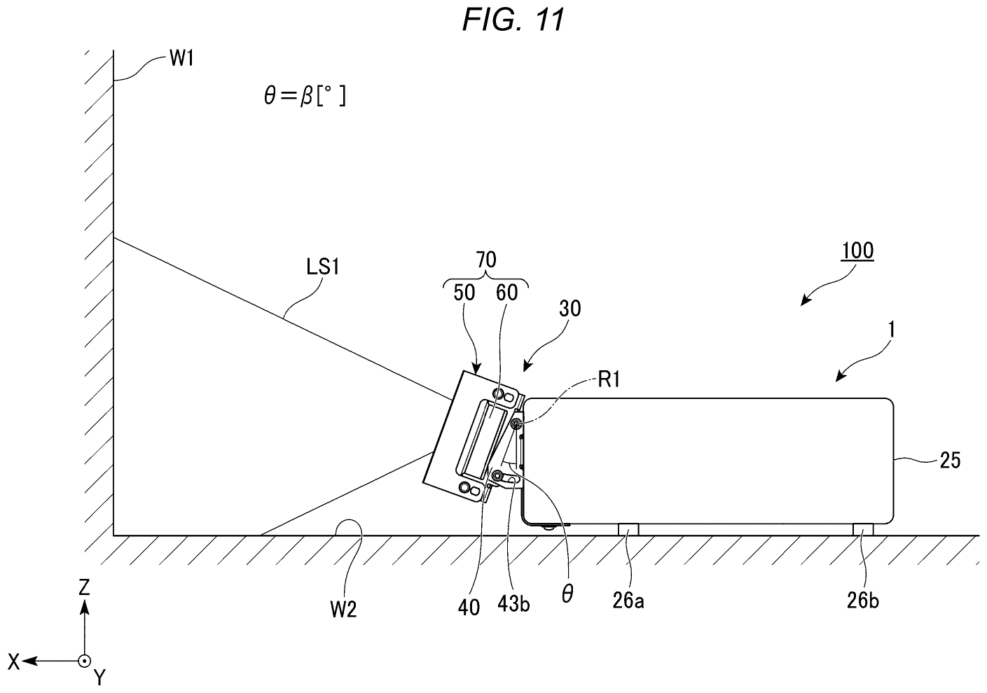

FIG. 9 is a partial cross-sectional view showing the adjustment mechanism 30, and shows a state in which the movable section 70 is rotated relative to the adjustment mechanism 30 shown in FIG. 8 around the axis of rotation R1. FIG. 10 s the projection system 100 viewed in the rightward-leftward direction Y in a state in which the movable section 70 is rotated relative to the projection system 100 shown in FIG. 2 around the axis of rotation R1. FIG. 11 shows the projection system 100 viewed in the rightward-leftward direction Y in a state in which the movable section 70 is further rotated relative to the projection system 100 shown in FIG. 10 around the axis of rotation R1. FIG. 10 shows a case where the angle of rotation θ of the movable section 70 is α[°]. FIGS. 9 and 11 show a case where the angle of rotation θ of the movable section 70 is β[°] greater than α[°]. In examples of FIGS. 9 to 11, α[°] is 10[°], and β[°] is 20[°]. The angles α[°] and β[°] are not limited to specific values.

In the present embodiment, the movable section 70 is relatively rotatable relative to the projection optical apparatus 6 around the axis of rotation R1 toward the upper side, that is, the first side in the second direction, as shown in FIGS. 9, 10, and 11. Note in the present specification that the expression “the movable section is rotatable around the axis of rotation toward a certain side” means that the position of the movable section only need to be changeable toward the certain side as the movable section rotates around the axis of rotation. As compared with the movable section 70 shown in FIGS. 2 and 8, FIGS. 9, 10, and 11 show the states in which the movable section 70 is rotated around the axis of rotation R1 in the direction in which the movable section 70 moves frontward and upward.

In the present embodiment, when the angle of rotation θ of the movable section 70 is 0[°], image light LP1a traveling in the frontward-rearward direction X along the optical axis AXP of the projection optical apparatus 6 out of the image light LP1 output from the projection optical apparatus 6 does not change its traveling direction even after the image light LP1a enters the optical element 60 and is output from the optical element 60 as image light LS1a along the optical axis AXS of the projection optical apparatus 6, as shown in FIG. 8. Out of the image light LP1 output from the projection optical apparatus 6, image light LP1b traveling in a direction inclining with respect to the optical axis AXP of the projection optical apparatus 6 enters the optical element 60, which changes the traveling direction of the image light LP1b to a direction that inclines by a greater amount with respect to the optical axis AXP, and the resultant image light is output as image light LS1b from the optical element 60. The inclination of the image light LS1b with respect to the optical axis AXS is greater than the inclination of the image light LP1b with respect to the optical axis AXP. The image light LP1b and the image light LS1b each travel upward as traveling frontward.

When the angle of rotation θ of the movable section 70 is greater than 0[°], the image light LP1a traveling in the frontward-rearward direction X along the optical axis AXP of the projection optical apparatus 6 out of the image light LP1 output from the projection optical apparatus 6 enters the optical element 60 at an inclined angle with respect to the optical axis AXS of the optical element 60, as shown in FIG. 9. The optical element 60 therefore changes the traveling direction of the image light LP1a to a direction that inclines by a greater amount with respect to the optical axis AXS of the optical element 60, and the resultant image light is output as image light LS1c from the optical element 60. When the angle of rotation θ of the movable section 70 is greater than 0[°], the image light LP1a along the optical axis AXP of the projection optical apparatus 6 inclines downward with respect to the optical axis AXS of the optical element 60. The traveling direction of the image light LS1c output from the optical element 60 is therefore changed to a direction that inclines downward by a greater amount with respect to the optical axis AXS. The image light LS1c therefore travels downward as traveling frontward.

The greater the inclination of the light incident on the optical element 60 with respect to the optical axis AXS, the greater the degree of the change in the traveling direction of the light due to the optical element 60. In the present embodiment, the greater the angle of rotation θ, the greater the inclination of the image light LP1a with respect to the optical axis AXS of the optical element 60. Therefore, the greater the angle of rotation θ, the greater the degree of change in the traveling direction of the image light LP1a due to the optical element 60, and the greater the inclination of the image light LS1c output from the optical element 60 with respect to the frontward-rearward direction X. That is, a greater angle of rotation θ causes the image light LS1c to incline downward by a greater amount.

When the angle of rotation θ of the movable section 70 is greater than 0[°], the image light LP1b traveling in a direction inclining with respect to the optical axis AXP of the projection optical apparatus 6 out of the image light LP1 output from the projection optical apparatus 6 inclines with respect to the optical axis AXS of the optical element 60 by a smaller amount than in the case where the angle of rotation θ is 0[°]. The degree of change in the traveling direction of the image light LP1b due to the optical element 60 is therefore smaller than in the case where the angle of rotation θ is 0[°]. In the example shown in FIG. 9, the image light LP1b travels in parallel to the optical axis AXS of the optical element 60, which therefore does not change the traveling direction of the image light LP1b, and the image light LP1b is output from the optical element 60 as image light LS1d parallel to the optical axis AXS.

As described above, the rotation of the movable section 70 around the axis of rotation R1 changes the inclination of the image light LP1 output from the projection optical apparatus 6 relative to the optical element 60, and therefore changes the degree of change in the traveling direction of the image light LP1 changed by the optical element 60. The adjustment mechanism 30, in which the movable section 70 is moved relative to the projection optical apparatus 6, thus changes the traveling direction of the image light LP1 projected from the projection optical apparatus 6. In the present embodiment, in which the movable section 70 rotates around the axis of rotation R1 upward relative to the projection optical apparatus 6, the greater the movable section 70 rotates, the greater the downward change in vertical direction Z in the traveling direction of the image light LS1 output from the optical element 60, as shown in FIGS. 10 and 11. Rotating the movable section 70 of the adjustment mechanism 30 thus allows the image light LS1 output from the optical element 60 to be projected not only onto the sidewall surface W1 but also onto the installation surface W2. As described above, the projection system 100 according to the embodiment can project light onto two or more surfaces oriented in different directions.

According to the present embodiment, the projection system 100 includes the light source 2, which outputs light, the light modulators 4R, 4G, and 4B, which modulate the light output from the light source 2, the projection optical apparatus 6, which projects the light modulated by the light modulators 4R, 4G, and 4B, and the adjustment mechanism 30, which is disposed at the side of the projection optical apparatus 6 toward which light is projected from the projection optical apparatus 6. The adjustment mechanism 30 includes the movable section 70 provided to be movable relative to the projection optical apparatus 6, and movement of the movable section 70 relative to the projection optical apparatus 6 changes the traveling direction of the light projected from the projection optical apparatus 6. The traveling direction of the light projected from the projection optical apparatus 6 can therefore be changed by the adjustment mechanism 30 without providing the projector 1 with a mechanism that moves the projection optical apparatus 6. The light projected from the projection optical apparatus 6 can therefore be readily projected to a desired location with an increase in the size of the projection system 100 suppressed. Specifically, in the present embodiment, the image light LP1 projected from the projection optical apparatus 6 can be projected not only onto the sidewall surface W1, which is located frontward of the projection system 100, but also onto the installation surface W2, on which the projection system 100 is installed.

According to the present embodiment, the movable section 70 includes the optical element 60, which the light projected from the projection optical apparatus 6 enters. The traveling direction of the light projected from the projection optical apparatus 6 can therefore be readily changed by the optical element 60.

Furthermore, according to the present embodiment, the optical element 60 is an optical element that widens the angle of view of the light projected from the projection optical apparatus 6. The light projected from the projection system 100 can therefore be more readily projected to a desired location. In particular, when the light projected from the projection optical apparatus 6 is projected in a direction offset upward from the optical axis AXP of the projection optical apparatus 6 as in the present embodiment, the light projected from the projection optical apparatus 6 is unlikely to be projected onto the installation surface W2. However, since the angle of view of the light projected from the projection optical apparatus 6 can be widened by the optical element 60 as in the present embodiment, the traveling direction of the light projected from the projection optical apparatus 6 can be changed downward by adjusting the angle of rotation θ of the movable section 70 as described above. The light projected from the projection optical apparatus 6 can thus be readily projected also onto the installation surface W2.

According to the present embodiment, the movable section 70 includes the holder 50, which holds the optical element 60. The holder 50 includes the first holding member 51 and the second holding member 52, which sandwich the optical element 60 in the direction in which the optical axis AXS of the optical element 60 extends. The first holding member 51 and the second holding member 52 are fixed to each other. The optical element 60 can therefore be readily and stably held by the holder 50. A filter or the like may be disposed at the light exiting side of the optical element 60, and the filter and the optical element 60 can be collectively sandwiched between and held by the first holding member 51 and the second holding member 52. The light output from the optical element 60 can thus be readily adjusted by the filter.

According to the present embodiment, the first fixing holes 57a, through which the threaded members 72, which fix the second holding member 52 to the first holding member 51, can pass, are formed in the second holding member 52. The projection system 100 satisfies the following two conditions: the first fixing holes 57a and the second fixing holes 57b are so formed in the second holding member 52 that the pairs of the two holes are each arranged side by side in the direction in which the optical axis AXS of the optical element 60 extends; and the first fixing holes 57a are each a hole elongated in the direction in which the optical axis AXS of the optical element 60 extends. The distance between the first holding member 51 and the second holding member 52 can therefore be changed by changing the fixing holes 57 through which the threaded members 72 pass from the first fixing holes 57a to the second fixing holes 57b or vice versa, or changing the positions where the threaded members 72 pass through in the first fixing holes 57a. More specifically, the distance between the first wall section 53 and the second wall section 55 can be changed. Any of multiple types of optical elements 60 having different dimensions in the direction in which the optical axis AXS extends can thus be sandwiched between and held by the first holding member 51 and the second holding member 52.

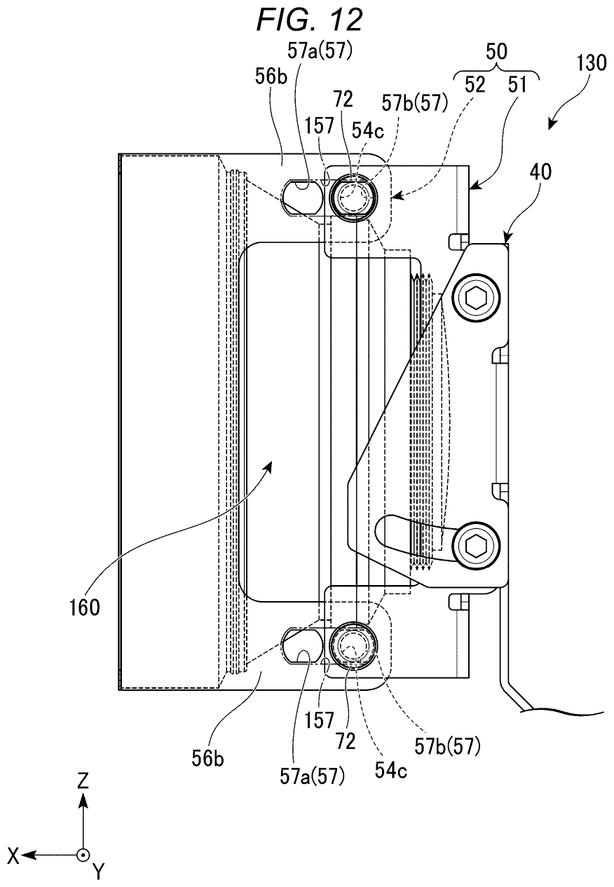

Specifically, for example, an optical element 160 having a greater dimension in the direction in which the optical axis AXS extends than the optical element 60 described above can be held by the holder 50, as shown in FIG. 12. FIG. 12 shows an adjustment mechanism 130 including the different optical element 160 and viewed in the rightward-leftward direction Y. In the adjustment mechanism 130, the threaded members 72 pass through the second fixing holes 57b located rearward of the first fixing holes 57a, as shown in FIG. 12. The dimension of the holder 50 in the direction in which the optical axis AXS extends is therefore greater than that of the adjustment mechanism 30 described above, so that the optical element 160 larger than the optical element 60 can be held.

Note that the projection system 100 satisfies only one of the following two conditions: the first fixing holes 57a and the second fixing holes 57b are so formed in the second holding member 52 that the pairs of the two holes are each arranged side by side in the direction in which the optical axis AXS of the optical element 60 extends; and the first fixing holes 57a are each a hole elongated in the direction in which the optical axis AXS of the optical element 60 extends. Even in this case, any of multiple types of optical elements 60 having different dimensions in the direction in which the optical axis AXS extends can be held by the holder 50. Furthermore, instead of providing multiple fixing holes 57 for each of the third linkage wall sections 56b of the second holding member 52, one first fixing hole 157 indicated by the two-dot chain line in FIG. 12 may be provided in each of the third linkage wall sections 56b. The first fixing holes 157 are each a single elongated hole configured with the aforementioned first fixing hole 57a and second fixing hole 57b linked to each other. Even in this case, the positions where the threaded members 72 pass through the first fixing holes 157 can be changed in the direction in which the optical axis AXS extends to change the dimension of the optical element 60 that can be held by the holder 50.

According to the present embodiment, the movable section 70 is rotatable with respect to the projection optical apparatus 6 around the axis of rotation R1, which extends in the rightward-leftward direction Y (first direction) perpendicular to the optical axis AXP of the projection optical apparatus 6. The traveling direction of the image light LP1 projected from the projection optical apparatus 6 can therefore be readily changed by rotating the movable section 70 around the axis of rotation R1.

According to the present embodiment, the image light LP1 projected from the projection optical apparatus 6 is projected in a direction offset from the optical axis AXP of the projection optical apparatus 6 upward (toward first side) in the vertical direction Z (second direction) perpendicular to both the optical axis AXP of the projection optical apparatus 6 and the rightward-leftward direction Y (first direction). The movable section 70 is rotatable relative to the projection optical apparatus 6 around the axis of rotation R1 upward (toward first side). The traveling direction of the image light LP1 offset upward can therefore be changed downward by using an optical element capable of widening the angle of view as the optical element 60 and rotating the optical element upward around the axis of rotation R1. The light output from the projection system 100 can thus be readily projected onto the installation surface W2.

According to the present embodiment, the projection system 100 includes the enclosure 25, which houses the light source 2 and the light modulators 4R, 4G, and 4B therein. The adjustment mechanism 30 includes the fixed member 40 fixed to the enclosure 25. The fixed member 40 has the support holes 43a, through which the axis of rotation R1 passes, and the guide holes 43b, which are disposed away from the support holes 43a in the radial direction from the axis of rotation R1 as the center and extends in the circumferential direction around the axis of rotation R1. The movable section 70 is attached to the fixed member 40 with the first threaded members 73a passing through the support holes 43a and the second threaded members 73b passing through the guide holes 43b. The movable section 70 can therefore be rotated around the axis of rotation R1 within the range over which the second threaded members 73b can relatively move in the guide holes 43b by loosening the first threaded members 73a and the second threaded members 73b. After the angle of rotation θ of the movable section 70 is set at a desired angle, the angle of rotation θ of the movable section 70 can be maintained at the desired angle by tightening the first threaded members 73a and the second threaded members 73b. The angle of rotation θ of the movable section 70 can therefore be readily adjusted, so that the traveling direction of the light projected from the projection system 100 can be readily adjusted by the adjustment mechanism 30.

According to the present embodiment, the adjustment mechanism 30 is an adjustment mechanism attached to the projector 1. The traveling direction of the light projected from the projection optical apparatus 6 of the projector 1 can therefore be changed by the adjustment mechanism 30 attached to the projector 1 without any change in the structure of the projector 1.

Embodiments different from the embodiment described above will be described below. In the description of the embodiments below, the same configurations as those described earlier than the description of the embodiments below have the same reference characters as appropriate or are otherwise described, and will not be described in some cases. In addition, portions corresponding to the sections having the configurations described earlier than the description of the embodiments below have same names but have different reference characters, and points different from those of the configurations described above will be described, but the same points as those of the configurations described above will not be described in some cases. Note that a configuration that is not described in the embodiments below can employ the same configuration as that described earlier than the embodiments below to the extent that no contradiction occurs.

### Second Embodiment

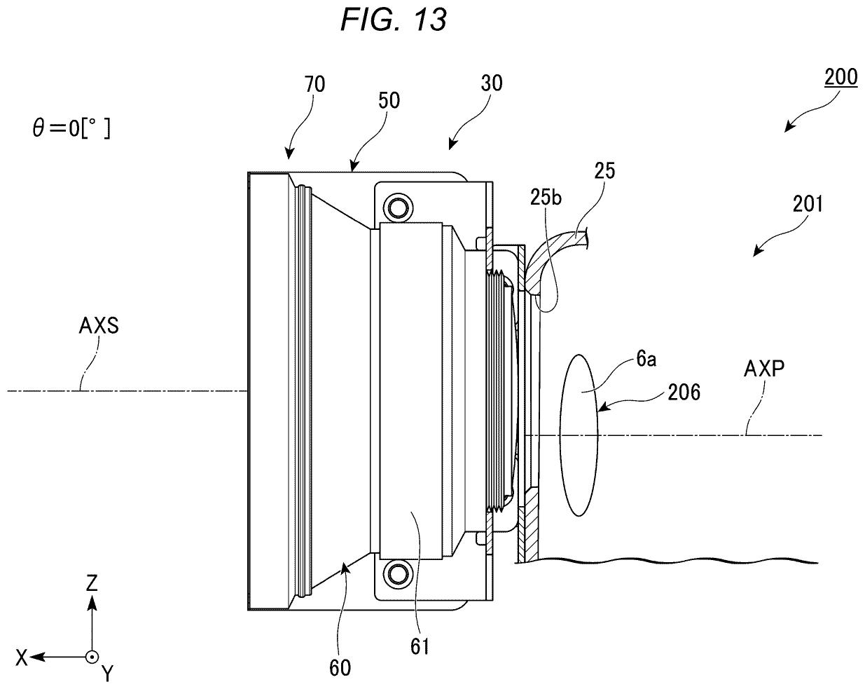

The present embodiment differs from the first embodiment in the relative positional relationship between a projection optical apparatus 206 and the adjustment mechanism 30. FIG. 13 is a partial cross-sectional view showing a portion of a projection system 200 according to the present embodiment.

The projection optical apparatus 206 in a projector 201 of the projection system 200 is located at a position lower than the position of the projection optical apparatus 6 in the first embodiment, as shown in FIG. 13. The optical axis AXP of the projection optical apparatus 206 is located at a level lower than the level of the optical axis AXS of the optical element 60 in the state in which the angle of rotation θ of the movable section 70 is 0[°] so that the optical axis AXP of the projection optical apparatus 206 is parallel to the optical axis AXS of the optical element 60. Other configurations of the projection system 200 are the same as those of the projection system 100 according to the first embodiment.

According to the present embodiment, the traveling direction of the light projected from the projection optical apparatus 206 can be changed by the adjustment mechanism 30, as in the first embodiment. The light output from the projection optical apparatus 206 can therefore be readily projected to a desired location with an increase in the size of the projection system 200 suppressed.

According to the present embodiment, the optical axis AXP of the projection optical apparatus 206 is shifted downward from the optical axis AXS of the optical element 60 in the state in which the optical axis AXP of the projection optical apparatus 206 and the optical axis AXS of the optical element 60 are parallel to each other. Therefore, when the light projected from the projection optical apparatus 206 is offset upward, the light projected from the projection optical apparatus 206 is likely to enter the optical element 60. The configuration described above can prevent vignetting of part of the light projected from the projection optical apparatus 206 due, for example, to the lens barrel 61 of the optical element 60.

### Third Embodiment

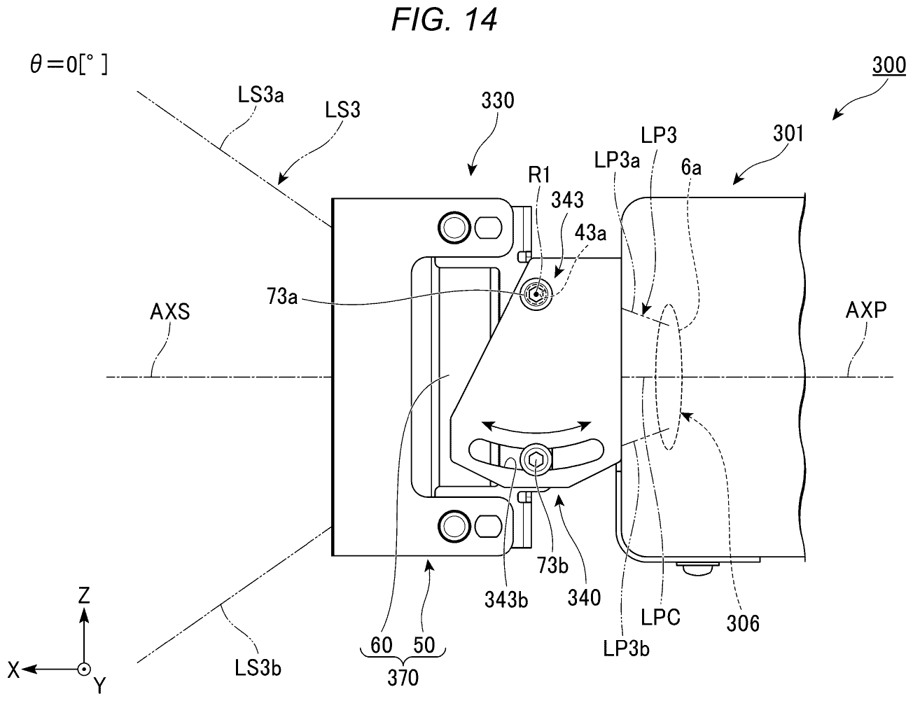

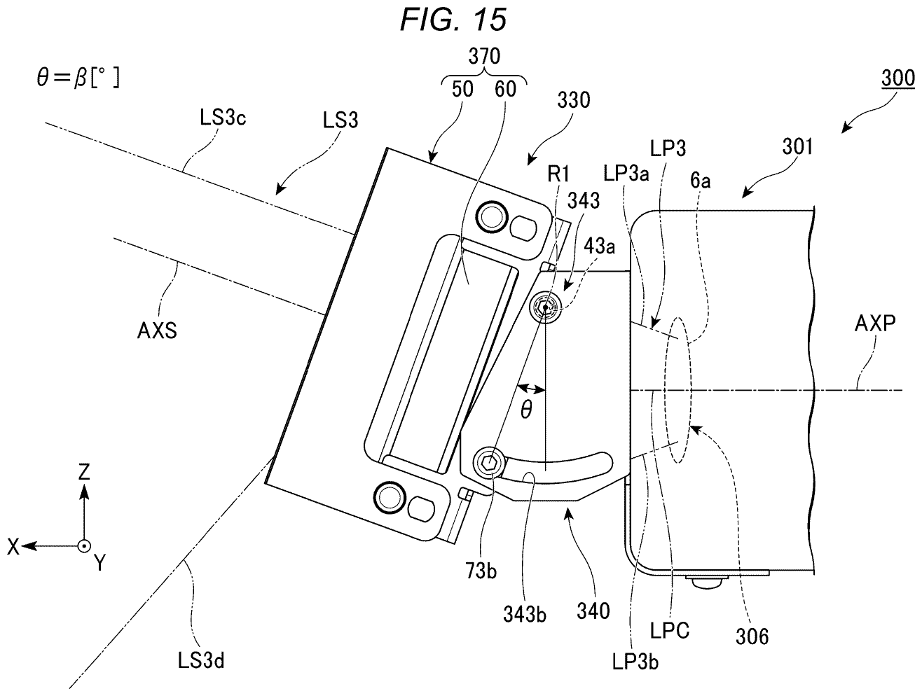

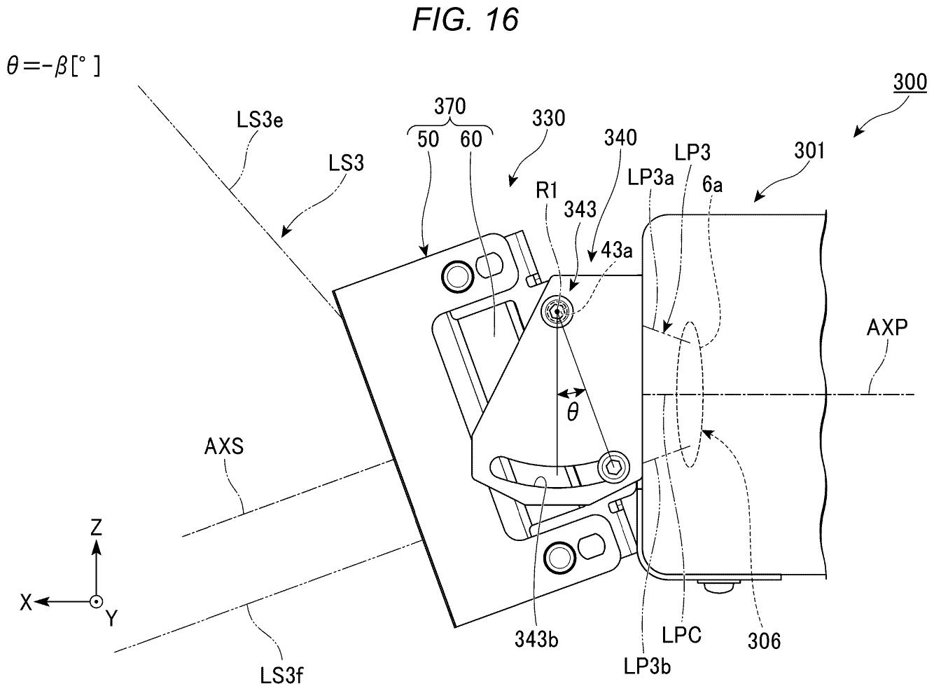

The present embodiment differs from the first embodiment in that an adjustment mechanism 330 is configured differently. FIG. 14 shows a portion of a projection system 300 according to the present embodiment viewed in the rightward-leftward direction Y. FIG. 15 shows a portion of the projection system 300 according to the present embodiment viewed in the rightward-leftward direction Y in a state in which a movable section 370 inclines upward. FIG. 16 shows a portion of the projection system 300 according to the present embodiment viewed in the rightward-leftward direction Y in a state in which the movable section 370 inclines downward.

Image light LP3 projected from a projection optical apparatus 306 in a projector 301 of the projection system 300 is projected in a direction not offset from the optical axis AXP of the projection optical apparatus 306 in the vertical direction Z (second direction) perpendicular to both the optical axis AXP of the projection optical apparatus 306 and the rightward-leftward direction Y (first direction), as shown in FIG. 14. That is, the center line LPC of the image light LP3 projected from the projection optical apparatus 306 coincides with the optical axis AXP. The image light LP3 projected from the projection optical apparatus 306 spreads, as traveling frontward, toward the opposite sides in the vertical direction Z and the opposite sides in the rightward-leftward direction Y from the optical axis AXP as the center.

Guide holes 343b formed in attachment sections 343 of a fixed member 340 of the adjustment mechanism 330 each have an arcuate shape around the axis of rotation R1. The guide holes 343b extend toward the opposite sides in the frontward-rearward direction X beyond the support holes 43a, through which the axis of rotation R1 passes. Therefore, in the present embodiment, the movable section 370 is rotatable relative to the projection optical apparatus 306 around the axis of rotation R1 upward (toward first side in second direction) and downward (toward second side in second direction) in the vertical direction Z. FIG. 15 shows a state in which the movable section 370 is rotated upward around the axis of rotation R1 with the second threaded members 73b passing through front end portions of the guide holes 343b. FIG. 16 shows a state in which the movable section 370 is rotated downward around the axis of rotation R1 with the second threaded members 73b passing through rear end portions of the guide holes 343b. The angle of rotation θ of the movable section 370 in FIG. 15 is β[°]. The angle of rotation θ of the movable section 370 in FIG. 16 is −β[°]. In FIG. 15, β[°] is 20[°], and in FIG. 16, −β[°] is −20[°].

In the present embodiment, since the image light LP3 projected from the projection optical apparatus 306 is not offset, the image light LP3 projected from the projection optical apparatus 306 contains image light LP3a traveling upward as traveling frontward and image light LP3b traveling downward as traveling frontward. In the present embodiment, when the angle of rotation θ of the movable section 370 is 0[°], the traveling directions of the image light LP3a and the image light LP3b are changed by the optical element 60 to directions that incline by greater amounts with respect to the optical axes AXP and AXS, and the resultant image light LP3a and image light LP3b are output as image light LS3a and image light LS3b from the optical element 60, as shown in FIG. 14. When the angle of rotation θ of the movable section 370 is 0[°], image light LS3 output from the optical element 60 spreads toward the opposite sides in the vertical direction Z and the opposite sides in the rightward-leftward direction Y by greater amounts than the image light LP3 output from the projection optical apparatus 306.

When the movable section 370 is rotated upward around the axis of rotation R1, the degree of change in the traveling direction of the image light LP3a is smaller than that in the case where the axis of rotation θ is 0[°], and the degree of change in the traveling direction of the image light LP3b is greater than that in the case where the angle of rotation θ is 0[°], as shown in FIG. 15. The image light LP3a is therefore output from the optical element 60 as image light LS3c, the traveling direction of which is not changed or changed by a small degree. The image light LP3b is output from the optical element 60 as image light LS3d, the traveling direction of which inclines downward by a greater amount than in the case where the angle of rotation θ is 0[°]. Therefore, when the movable section 370 is rotated upward around the axis of rotation R1, the image light LS3 output from the optical element 60 spreads downward by a greater amount than in the case where the angle of rotation θ is 0[°].

When the rotation angle θ of the movable section 370 is rotated downward around the axis of rotation R1, the degree of change in the traveling direction of the image light LP3a is greater than that in the case where the axis of rotation θ is 0[°], and the degree of change in the traveling direction of the image light LP3b is smaller than that in the case where the angle of rotation θ is 0[°], as shown in FIG. 16. The image light LP3b is therefore output from the optical element 60 as image light LS3f, the traveling direction of which is not changed or changed by a small degree. The image light LP3a is output from the optical element 60 as image light LS3e, the traveling direction of which inclines upward by a greater amount than in the case where the angle of rotation θ is 0[°]. Therefore, when the movable section 370 is rotated downward around the axis of rotation R1, the image light LS3 output from the optical element 60 spreads upward by a greater amount than in the case where the angle of rotation θ is 0[°]. Other configurations of the projection system 300 are the same as those of the projection system 100 according to the first embodiment.

According to the present embodiment, the traveling direction of the light projected from the projection optical apparatus 306 can be changed by the adjustment mechanism 330, as in the first embodiment. The light output from the projection optical apparatus 306 can therefore be readily projected to a desired location with an increase in the size of the projection system 300 suppressed.

According to the present embodiment, the image light LP3 projected from the projection optical apparatus 306 is projected in a direction not offset from the optical axis AXP of the projection optical apparatus 306 in the vertical direction (second direction) Z perpendicular to both the optical axis AXP of the projection optical apparatus 306 and the rightward-leftward direction (first direction) Y. The movable section 370 is rotatable relative to the projection optical apparatus 306 around the axis of rotation R1 upward (toward first side in second direction) and downward (toward second side in second direction). The image light LS3 output from the optical element 60 can be spread to the opposite sides in the vertical direction Z by changing the direction in which the movable section 370 is rotated, as described above. The light output from the projection optical apparatus 306 can therefore be more readily projected to a desired location.

### Fourth Embodiment

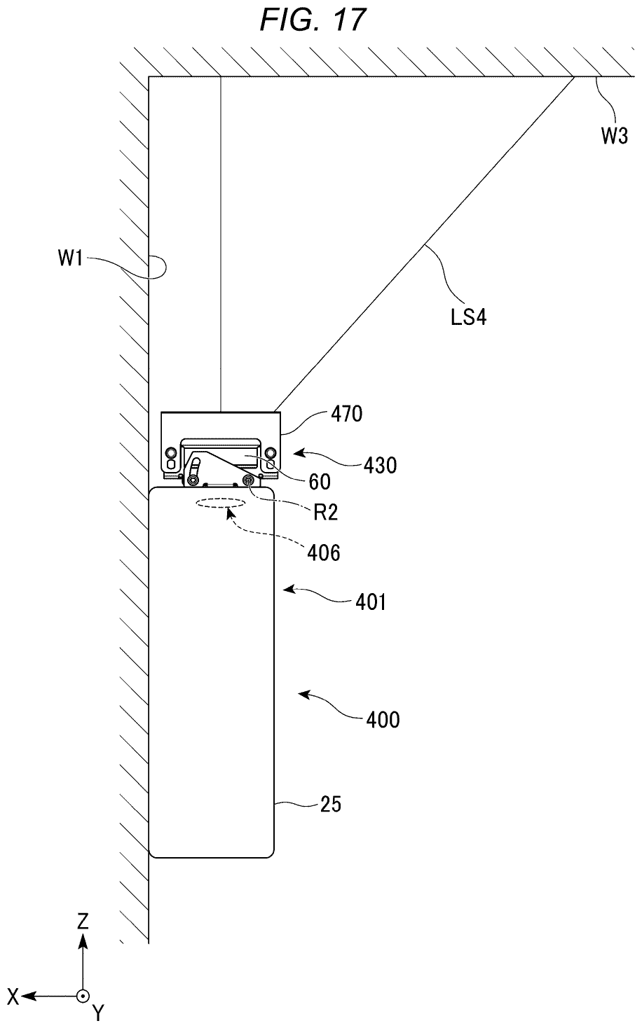

The present embodiment differs from the first embodiment in the location at which a projection system 400 is installed. FIG. 17 shows the projection system 400 according to the present embodiment. In the present embodiment, the rightward-leftward direction Y corresponds to the “first direction”, the frontward-rearward direction X corresponds to the “second direction”, and the rear side corresponds to the “first side in the second direction”.

The projection system 400 according to the present embodiment is attached to the sidewall surface W1, as shown in FIG. 17. In more detail, the enclosure 25 of a projector 401 is attached to the sidewall surface W1. The projection system 400 has the same structure as the projection system 100 according to the first embodiment except that neither the front leg 26a nor the rear legs 26b are provided. The projection system 400 is attached to the sidewall surface W1 with the posture of the projection system 400 rotated by 90° around an axis extending in the rightward-leftward direction Y as compared with the projection system 100 according to the first embodiment.

The projection system 400 includes the projector 401 and an adjustment mechanism 430. A projection optical apparatus 406 of the projector 401 outputs image light upward. In the present embodiment, the image light output from the projection optical apparatus 406 is offset rearward. The adjustment mechanism 430 is located upward of the projection optical apparatus 406. Image light LS4 output from adjustment mechanism 430 is projected onto a ceiling surface W3. The ceiling surface W3 is a surface facing downward. In the present embodiment, the traveling direction of the image light LS4 output from the projection system 400 is changed to the frontward direction by a movable section 470 of the adjustment mechanism 430 rotating rearward around an axis of rotation R2, and the image light LS4 is projected onto two surfaces, the sidewall surface W1 and the ceiling surface W3. The axis of rotation R2 is an imaginary axis extending in the rightward-leftward direction Y. Other configurations of the projection system 400 are the same as those of the projection system 100 according to the first embodiment.

According to the present embodiment, the light output from the projection optical apparatus 406 can be readily projected to a desired location with an increase in the size of the projection system 400 suppressed, as in the embodiments described above.

Embodiments of the present disclosure are not limited to the embodiments described above, and the following configurations and methods can also be employed. The adjustment mechanism may have any structure in which a movable section is provided to be movable relative to a projection optical apparatus, and the traveling direction of the light projected from the projection optical apparatus can be changed by the movable section moving relative to the projection optical apparatus. When the movable section includes an optical element, the optical element may be an optical element of any type. When the optical element is an optical element that widens the angle of view of light projected from the projection optical apparatus, the optical element may be a fisheye lens. In this case, since the angle of view of the light projected from the projection optical apparatus can be widened to about 180°, the light can be projected onto multiple surfaces without any adjustment of the movable section in the adjustment mechanism. The optical element may instead be an optical element that narrows the angle of view of the light projected from the projection optical apparatus. In this case, the light can be readily projected onto multiple surfaces located relatively far away from the projection system. The optical element may be a mirror that reflects light.

The movable section of the adjustment mechanism only needs to be provided to be movable relative to the projection optical apparatus, and may be moved in any manner relative to the projection optical apparatus. The movable section may be provided to be slidable relative to the projection optical apparatus. When the movable section is rotatable relative to the projection optical apparatus around an axis of rotation, a first direction in which the axis of rotation extends is not limited to a specific direction and may be any direction perpendicular to the optical axis of the projection optical apparatus. The first direction may be the vertical direction Z in the first embodiment described above. In this case, the traveling direction of the light projected from the projection optical apparatus can be adjusted in the rightward-leftward direction Y. The adjustment mechanism may be a portion of the projector. In this case, at least a portion of the adjustment mechanism may be housed in the enclosure of the projector.

The aforementioned first embodiment has been described with reference to the case where the present disclosure is applied to a transmissive projector, and the present disclosure is also applicable to a reflective projector. The term “transmissive” means that the light modulators including liquid crystal panels or the like transmit light. The term “reflective” means that the light modulators reflect light. Note that the light modulators are not limited to liquid crystal panels or the like, and may, for example, be light modulators using micromirrors.

The aforementioned first embodiment has been described with reference to the projector 1 using the three light modulators 4R, 4G, and 4B as an example, and the present disclosure is also applicable to a projector using only one light modulator and a projector using four or more light modulators.

The configurations and methods described in the present specification can be combined with each other as appropriate to the extent that no contradiction occurs.

### Summary of Present Disclosure

The present disclosure will be summarized below as additional remarks.

### Additional Remark 1

A projection system including:
a light source configured to output light;
a light modulator configured to modulate the light output from the light source;
a projection optical apparatus configured to project the light modulated by the light modulator; and
an adjustment mechanism disposed at a side of the projection optical apparatus toward which the light is projected from the projection optical apparatus,
wherein the adjustment mechanism includes a movable section provided to be movable relative to the projection optical apparatus, and is so configured that a traveling direction of the light projected from the projection optical apparatus is changed by the movable section moving relative to the projection optical apparatus.

According to the configuration described above, the traveling direction of the light projected from the projection optical apparatus can be changed by the adjustment mechanism without providing the projector with a mechanism that moves the projection optical apparatus. The light projected from the projection optical apparatus can therefore be readily projected to a desired location with an increase in the size of the projection system suppressed.

### Additional Remark 2

The projection system according to the additional remark 1, wherein the movable section includes an optical element that the light projected from the projection optical apparatus enters.

According to the configuration described above, the traveling direction of the light projected from the projection optical apparatus can be readily changed by the optical element.

### Additional Remark 3

The projection system according to the additional remark 2, wherein the optical element is an optical element that widens an angle of view of the light projected from the projection optical apparatus.

According to the configuration described above, the light projected from the projection system can be more readily projected to a desired location. In particular, when the light projected from the projection optical apparatus is projected in a direction offset from the optical axis of the projection optical apparatus, the light projected from the projection optical apparatus is unlikely to be projected onto the installation surface at which the projection system is installed. However, since the angle of view of the light projected from the projection optical apparatus can be widened by the optical element, the light projected from the projection optical apparatus can be changed by adjusting the angle of rotation of the movable section so as to travel toward the installation surface. The light projected from the projection optical apparatus can thus be readily projected also onto the installation surface, at which the projection system is installed.

### Additional Remark 4

The projection system according to the additional remark 2 or 3, wherein
the movable section includes a holder configured to hold the optical element,
the holder includes a first holding member and a second holding member configured to sandwich the optical element in a direction in which an optical axis of the optical element extends, and
the first holding member and the second holding member are fixed to each other.

According to the configuration described above, the optical element can be readily and stably held by the holder. Furthermore, a filter or the like can be disposed at the light exiting side of the optical element, and the filter and the optical element can be collectively sandwiched between and held by the first holding member and the second holding member. The light output from the optical element can thus be readily adjusted by the filter.

### Additional Remark 5

The projection system according to the additional remark 4, wherein
the second holding member has a first fixing hole formed therein through which a threaded member is passable, the threaded member configured to fix the second holding member to the first holding member, and
at least one of two conditions is satisfied: a second fixing hole is formed along with the first fixing hole side by side in the second holding member in a direction in which the optical axis of the optical element extends; and the first fixing hole is a hole elongated in the direction in which the optical axis of the optical element extends.

According to the configuration described above, the distance between the first holding member and the second holding member can be changed by changing the fixing hole through which the threaded member passes from the first fixing hole to the second fixing hole or vice versa, or changing a position where the threaded member passes through in the first fixing hole. Any of multiple types of optical elements having different dimensions in the direction in which the optical axis extends can thus be sandwiched between and held by the first holding member and the second holding member.

### Additional Remark 6

The projection system according to any one of the additional remarks 1 to 5, wherein the movable section is rotatable with respect to the projection optical apparatus around an axis of rotation extending in a first direction perpendicular to an optical axis of the projection optical apparatus.

According to the configuration described above, the traveling direction of the light projected from the projection optical apparatus can be readily changed by rotating the movable section around the axis of rotation.

### Additional Remark 7

The projection system according to the additional remark 6, wherein
the light projected d from the projection optical apparatus is projected in a direction offset from the optical axis of the projection optical apparatus toward a first side in a second direction perpendicular to both the optical axis of the projection optical apparatus and the first direction, and
the movable section is rotatable relative to the projection optical apparatus around the axis of rotation toward the first side.

According to the configuration described above, the traveling direction of the light offset toward the first side can be changed toward a second side opposite the first side by replacing the optical element with an optical element capable of widening the angle of view and rotating the optical element around the axis of rotation toward the first side. The light output from the projection system can thus be readily projected onto the installation surface, at which the projection system is installed.

### Additional Remark 8

The projection system according to the additional remark 6, wherein
the light projected from the projection optical apparatus is projected in a direction not offset from the optical axis of the projection optical apparatus in a second direction perpendicular to both the optical axis of the projection optical apparatus and the first direction, and
the movable section is rotatable relative to the projection optical apparatus around the axis of rotation toward each of a first side in the second direction and a second side in the second direction.

According to the configuration described above, the light output from the optical element can be spread to the opposite sides in the second direction by changing the direction in which the movable section is rotated. The light output from the projection optical apparatus can therefore be more readily projected to a desired location.

### Additional Remark 9

The projection system according to any one of the additional remarks 6 to 8, further including
an enclosure configured to house the light source and the light modulator,
wherein the adjustment mechanism includes a fixed member fixed to the enclosure,
the fixed member has two holes formed therein,
a support hole through which the axis of rotation passes, and
a guide hole disposed away from the support hole in a radial direction from the axis of rotation as a center and extending in a circumferential direction around the axis of rotation, and
the movable section is attached to the fixed member with a first threaded member passing through the support hole and a second threaded member passing through the guide hole.

According to the configuration described above, the movable section can be rotated around the axis of rotation within the range over which the second threaded member can relatively move in the guide hole by loosening the first threaded member and the second threaded member. After the angle of rotation of the movable section is set at a desired angle, the angle of rotation of the movable section can be maintained at the desired angle by tightening the first threaded member and the second threaded member. The angle of rotation of the movable section can therefore be readily adjusted, so that the traveling direction of the light projected from the projection system can be readily adjusted by the adjustment mechanism.

### Additional Remark 10

An adjustment mechanism attached to a projector including a light source configured to output light, a light modulator configured to modulate the light output from the light source, and a projection optical apparatus configured to project the light modulated by the light modulator, the adjustment mechanism including
a movable section provided to be movable relative to the projection optical apparatus,
wherein the adjustment mechanism is disposed at a side of the projection optical apparatus toward which the light is projected from the projection optical apparatus, and
the adjustment mechanism is so configured that a traveling direction of the light projected from the projection optical apparatus is changed by the movable section moving relative to the projection optical apparatus.

According to the configuration described above, the traveling direction of the light projected from the projection optical apparatus of the projector can be changed by the adjustment mechanism attached to the projector without any change in the structure of the projector.

What is claimed is:

1. A projection system comprising:
a light source configured to output light;
a light modulator configured to modulate the light output from the light source;
a projection optical apparatus configured to project the light modulated by the light modulator; and
an adjustment mechanism disposed at a side of the projection optical apparatus toward which the light is projected from the projection optical apparatus,
wherein the adjustment mechanism includes a movable section provided to be movable relative to the projection optical apparatus, and is so configured that a traveling direction of the light projected from the projection optical apparatus is changed by the movable section moving relative to the projection optical apparatus.

2. The projection system according to claim 1, wherein
the movable section includes an optical element that the light projected from the projection optical apparatus enters.

3. The projection system according to claim 2, wherein
the optical element is an optical element that widens an angle of view of the light projected from the projection optical apparatus.

4. The projection system according to claim 2, wherein
the movable section includes a holder configured to hold the optical element,
the holder includes a first holding member and a second holding member configured to sandwich the optical element in a direction in which an optical axis of the optical element extends, and
the first holding member and the second holding member are fixed to each other.

5. The projection system according to claim 4, wherein
the second holding member has a first fixing hole formed therein through which a threaded member is passable, the threaded member configured to fix the second holding member to the first holding member, and
at least one of two conditions is satisfied: a second fixing hole is formed along with the first fixing hole side by side in the second holding member in a direction in which the optical axis of the optical element extends; and the first fixing hole is a hole elongated in the direction in which the optical axis of the optical element extends.

6. The projection system according to claim 1, wherein
the movable section is rotatable with respect to the projection optical apparatus around an axis of rotation extending in a first direction perpendicular to an optical axis of the projection optical apparatus.

7. The projection system according to claim 6, wherein
the light projected from the projection optical apparatus is projected in a direction offset from the optical axis of the projection optical apparatus toward a first side in a second direction perpendicular to both the optical axis of the projection optical apparatus and the first direction, and
the movable section is rotatable relative to the projection optical apparatus around the axis of rotation toward the first side.

8. The projection system according to claim 6, wherein
the light projected from the projection optical apparatus is projected in a direction not offset from the optical axis of the projection optical apparatus in a second direction perpendicular to both the optical axis of the projection optical apparatus and the first direction, and
the movable section is rotatable relative to the projection optical apparatus around the axis of rotation toward each of a first side in the second direction and a second side in the second direction.

9. The projection system according to claim 6, further comprising
an enclosure configured to house the light source and the light modulator,
wherein the adjustment mechanism includes a fixed member fixed to the enclosure,
the fixed member has two holes formed therein,
a support hole through which the axis of rotation passes, and
a guide hole disposed away from the support hole in a radial direction from the axis of rotation as a center and extending in a circumferential direction around the axis of rotation, and
the movable section is attached to the fixed member with a first threaded member passing through the support hole and a second threaded member passing through the guide hole.

10. An adjustment mechanism attached to a projector including a light source configured to output light, a light modulator configured to modulate the light output from the light source, and a projection optical apparatus configured to project the light modulated by the light modulator, the adjustment mechanism including
a movable section provided to be movable relative to the projection optical apparatus,
wherein the adjustment mechanism is disposed at a side of the projection optical apparatus toward which the light is projected from the projection optical apparatus, and
the adjustment mechanism is so configured that a traveling direction of the light projected from the projection optical apparatus is changed by the movable section moving relative to the projection optical apparatus.
